(19) United States
(12) Patent Application Publication
(10) Pub. No.: US 2018/0285438 A1
(43) Pub. Date: Oct. 4, 2018

(54) DATABASE SYSTEM AND METHOD FOR IDENTIFYING A SUBSET OF RELATED REPORTS

(71) Applicant: CHANGE HEALTHCARE HOLDINGS, LLC, Nashville, TN (US)

(72) Inventor: Mahmoud Ramze REZAEE, North Vancouver (CA)

(73) Assignee: CHANGE HEALTHCASE HOLDINGS, LLC, Nashville, TN (US)

(21) Appl. No.: 15/475,947

(22) Filed: Mar. 31, 2017

(51) Int. Cl. G06F 17/30

(52) U.S. Cl. CPC G06F 17/30592; G06F 17/30867; G06F 17/30598

(57) ABSTRACT

A database system, method and computer program product conduct efficient searches of a database to reliably identify a subset of relevant reports. The database system includes report encoding circuitry to encode a first report into a feature vector based upon the content of the first report. The database system also includes report identification circuitry to identify a closest prototype of the feature vector representative of the first report from among a plurality of prototypes. Each prototype is representative of a cluster of feature vectors of respective reports stored in a database. From among the cluster of feature vectors of respective reports of the closest prototype, the report identification circuitry identifies one or more of the feature vectors that are closest to the feature vector representative of the first report and provides an indication of the respective report(s) represented by the one or more feature vectors that have been identified.

### TECHNOLOGICAL FIELD

An example embodiment relates generally to a database system and method for identifying a subset of reports and, more particularly, to a database system, method and computer program product for efficiently identifying, for a respective report, the most related reports stored in a database based upon an analysis of the feature vectors representative of the respective reports.

### BACKGROUND

Reports are generated for a number of different applications in order to record information, memorialize conclusions, set forth plans of action or for other purposes. By way of example, many different types of medical reports are generated on a daily basis, such as radiology reports, cardiology reports, clinical notes, etc. Each of these different types of medical reports provides a record of medical information associated with a particular patient and, in some instances, may include observations and/or a treatment plan provided by a healthcare professional. Regardless of the application, the reports are commonly stored in a database.

In many instances, it would be desirable to identify one or more reports stored in the database that are closest or most related to a respective report, such as a report that is currently being prepared or otherwise under consideration. With respect to medical reports, for example, the healthcare practitioner may be reviewing a medical report for a particular patient and may desire to see the most related reports for other patients that are stored in the database in order to review the treatment plans that the other patients underwent as well as the patient outcomes following administration of the various treatment plans.

As a result of the multitude of reports typically stored in a database, however, searching for the most related reports within the database may prove to be time consuming and inefficient, if possible at all. The difficulty in performing such searches may be exacerbated by the free form nature of many reports, including many medical reports, which results in reports that fail to follow a template and that may have widely varying content depending upon, for example, the type of examination, the imaging modality, the healthcare professional or the like. With respect to medical records, for example, a single hospital may store millions of medical records in a year or over the course of several years. The number of medical reports grows even larger for the databases of healthcare organizations that operate multiple hospitals having a centralized database. As such, a conventional word search of the records stored in such a database in an effort to identify reports that are related to a report that is now being prepared or otherwise studied may take an exceedingly long time in order to obtain a result and may undesirably expend significant computing resources to perform the search. Indeed, as the database grows as more records are added over time, there is an increasing possibility that for database searches that are sufficiently complicated involving, for example, multiple words in a predefined relationship, the search may be eventually terminated without returning a result as the search may take more time than is permitted by the database system.

### BRIEF SUMMARY

A database system, method and computer program product are provided in accordance with an example embodiment in order to conduct efficient searches of a database in order to reliably identify a subset of relevant reports. In this regard, the database system, method and computer program product leverage the manner in which the reports are represented by the database to permit the most relevant reports to be identified in an efficient manner, even as the databases grow larger. Thus, the competing resources, including the time expended in the search and the processing resources required to conduct the search, may advantageously be reduced relative to conventional word searching techniques while consistently returning the desired results, thereby improving the corresponding functionality of the database system.

In an example embodiment, a database system configured to identify a subset of reports is provided. The database system includes report encoding circuitry configured to encode a first report into a feature vector based upon the content of the first report. The database system also includes report identification circuitry configured to identify a closest prototype of the feature vector representive of the first report from among a plurality of prototypes. Each prototype is representative of a cluster of feature vectors of respective reports stored in a database and, in one embodiment, may also represent a center point of the feature vectors of the respective cluster. From among the cluster of feature vectors of respective reports of the closest prototype, the report identification circuitry is configured to identify one or more of the feature vectors that are closest to the feature vector representative of the first report. The report identification circuitry is further configured to provide an indication of the respective report(s) represented by the one or more feature vectors identified to be closest to the feature vector representative to the first report.

In an example embodiment, the first report and the respective reports stored in the database have metadata associated herewith. In this embodiment, the report encoding circuitry is configured to encode the first report by encoding the first report into the feature vector based upon the content of the first report and the metadata associated with first report. Additionally or alternatively the report identification circuitry of this example embodiment is further configured to filter the plurality of prototypes based upon the metadata associated with first report such that the plurality of prototypes from which the closest prototype is identified are each representative of a cluster of feature vectors of respective reports having metadata associated therewith which corresponds to the metadata associated with the first report.

In an example embodiment, the feature vectors representative of the first report and the respective reports stored in a database are based upon words included in the reports. In this embodiment, the report encoding circuitry is configured to encode the first report into a feature vector by encoding the first report into a multi-dimensional feature vector with each dimension representative of the presence or absence of one or more words within the first report. The report identification circuitry of an example embodiment is configured to identify the closest prototype by identifying the prototype that has a shortest Euclidian distance to the feature vector representative of the first report as the closest prototype. The report identification circuitry of an example embodiment is configured to identify one or more of the feature vectors that are closest to the feature vector representative of the first report by identifying the one or more feature vectors from among the respective reports of the closest prototype that have the closest Euclidian distance to the feature vector representative of the first report as the closest feature vector(s).

In another embodiment, a method for identifying a subset of reports is provided that includes encoding, with report encoding circuitry, a first report into a feature vector based upon the content of the first report. The method also includes identifying, with report identification circuitry, the closest prototype to the feature vector representative of the first report from among the plurality of prototypes. Each prototype is representative of a cluster of feature vectors of respective reports stored in a database and, in one embodiment, is representative of a center point of the feature vectors of the respective cluster. The method also includes identifying, with the report identification circuitry and from among the cluster of feature vectors of respective reports of the closest prototype, one or more of the feature vectors that are closest to the feature vector representative of the first report. The method further includes providing, with the report identification circuitry, an indication of the respective report(s) represented by the one or more featured vectors identified to be closest to the feature vector representative of the first report.

In an example embodiment, the first report and the respective reports stored in the database have metadata associated therewith. The method of this example embodiment encodes the first report by encoding the first report into the feature vector based upon the content of the first report and the metadata associated with the first report. Additionally or alternatively, the method of this embodiment also includes filtering the plurality of prototypes based upon the metadata associated with the first report such that the plurality of prototypes from which the closest prototype is identified are each representative of a cluster of feature vectors of respective reports having metadata associated therewith which corresponds to the metadata associated with the first report.

In an example embodiment, the feature vectors representative of the first report and the respective reports stored in the database are based upon words included in the reports. In this example embodiment, the method encodes the first report into a feature vector by encoding the first report into a multi-dimensional feature vector with each dimension representative of the presence or absence of one or more words within the first report. The method of an example embodiment identifies the closest prototype by identifying the prototype that has the shortest Euclidean distance to the feature vector representative of the first report as the closest prototype. The method of an example embodiment identifies one or more of the feature vectors that are closest to the feature vector representative of the first report by identifying the one or more feature vectors of the respective reports of the closest prototype that have the shortest Euclidean distance to the feature vector representative of the first report as the closest feature vector(s).

In a further example embodiment, a computer program product is provided for identifying a subset of reports. The computer program product includes at least one non-transitory computer-readable storage medium storing computer-executable instructions that, when executed, cause an apparatus to encode a first report into a feature vector based upon content of the first report. The computer-executable instructions, when executed, also cause an apparatus to identify the closest prototype to the feature vector representative of the first report from among a plurality of prototypes. Each prototype is representative of a cluster of feature vectors of respective reports stored in a database. The computer-executable instructions, when executed, also cause an apparatus to identify, from among the cluster of feature vectors of respective reports of the closest prototype, one or more of the feature vectors that are the closest to the feature vector representative to the first report. The computer-executable instructions, when executed, further cause the apparatus to provide an indication of the respective report(s) represented by the one or more feature vectors identified to be the closest to the feature vector representative of the first report.

In an example embodiment, the first report and the respective reports stored in the database have metadata associated herewith. In this embodiment, the computer-executable instructions for encoding the first report include computer-executable instructions configured to encode the first report into the feature vector based upon the content of the first report and the metadata associated with the first report. Additionally or alternatively, the computer-executable instructions may be further configured to filter the plurality of prototypes based upon the metadata associated with the first report such that the plurality of prototypes from which the closest prototype is identified are each representative of a cluster of feature vectors of respective reports having metadata associated therewith which corresponds to the metadata associated with the first report. In an example embodiment, the feature vectors representative of the first report and the respective reports stored in the database are based upon words included in the respective reports. In this example embodiment, the computer-executable instructions for encoding the first report into the feature vector may include computer-executable instructions configured to encode the first report into a multi-dimensional feature vector with each dimension representative of the presence or absence of one or more words within the first report.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of a database system in accordance with an example embodiment of the present disclosure;

FIG. 2 is a flowchart illustrating the operations performed, such as by the database system of FIG. 1, in order to encode and cluster a plurality of reports in accordance with an example embodiment of the present disclosure;

FIG. 3 provides a representation of the encoding of a plurality of reports into respective feature vectors as well as the resulting clustering of a plurality of feature vectors in accordance with an example embodiment of the present disclosure; and

FIG. 4 is a flowchart illustrating operations performed, such as by the database system of FIG. 1, in order to identify the closest and most relevant reports in accordance with an example embodiment of the present disclosure.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

A database system, method and computer program product are provided in accordance with an example embodiment in order to identify a subset of reports. The reports that are stored and then evaluated for purposes of identifying a subset of the reports may be any of a variety of different types of reports. By way of example, but not of limitation, the database system, method and computer program product of an example embodiment will be described herein in conjunction with the storage and evaluation of a plurality of medical reports, such as radiology reports, cardiology reports, clinical notes or the like, in order to identify a subset of the medical reports. Although the reports may have a structured form, the reports may alternatively be free form so as to follow no particular template or standard and, instead, to permit text or other information to be entered freely into the report. The reports may be stored in a database, such as may be embodied by one or more memory devices, one or more servers, a cloud computing system or the like.

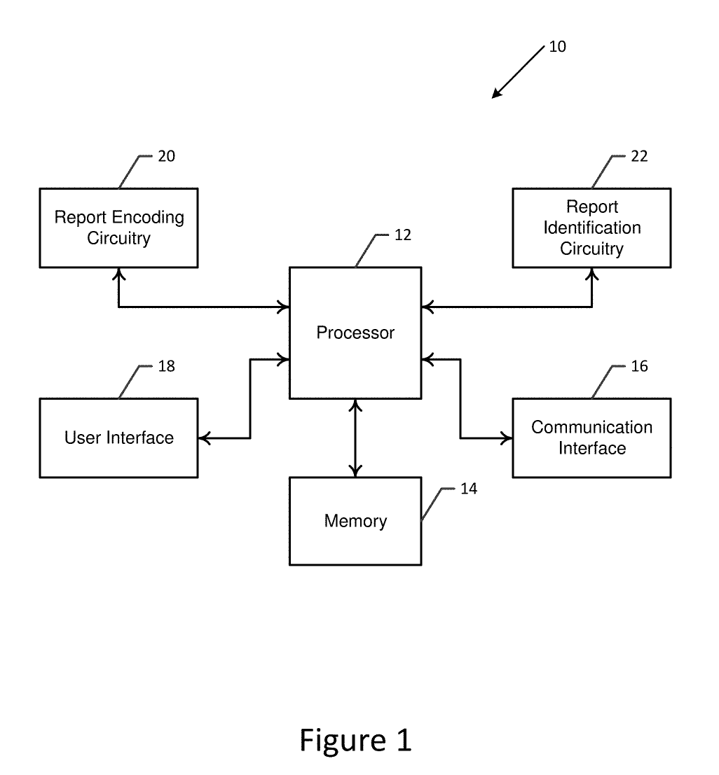

The database system may be embodied by any of a variety of computing devices including, for example, a server, a plurality of networked computing devices, a computer workstation, a picture archiving and communications system (PACS) or the like. Regardless of the manner in which the database system is embodied, the database system 10 of an example embodiment is depicted in FIG. 1 and generally includes, is associated with or is otherwise in communication with a processor 12 and memory 14, and optionally a communication interface 16 and a user interface 18. As also described below, the database system of an example embodiment includes, is associated with or is in communication with report encoding circuitry 20 and report identification circuitry 22.

The processor 12 may be embodied in a number of different ways. For example, the processor may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor may comprise a plurality of processors. The plurality of processors may be in operative communication with each other and may be collectively configured to perform one or more functionalities described herein. The plurality of processors may be embodied on a single computing device or distributed across a plurality of computing devices collectively configured to function as the database system 10. In some example embodiments, the processor may be configured to execute instructions stored in the memory 14 or otherwise accessible to the processor. As such, whether configured by hardware or by a combination of hardware and software, the processor may represent an entity (e.g., physically embodied in circuitry—in the form of processing circuitry) capable of performing operations according to embodiments of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform one or more operations described herein.

As shown in FIG. 1, the database system 10 may also include several specifically configured types of circuitry configured to perform different functions as described below. In this regard, the database system of an example embodiment includes report encoding circuitry 20 and/or report identification circuitry 22. In one embodiment, the processor 12 embodies one or more of the report encoding circuitry and/or report identification circuitry. Alternatively, the report encoding circuitry and/or report identification circuitry may be discrete circuitry, separate from, but in communication with, the processor. In this alternative embodiment, each of the report encoding circuitry and/or report identification circuitry may be embodied in any of the various manners described above with respect to the processor including embodiments comprised exclusively of hardware or embodiments in which the execution of software by hardware serves to specifically configure the hardware to perform the respective functions.

In some example embodiments, the memory 14 may include one or more non-transitory memory devices such as, for example, volatile and/or non-volatile memory that may be either fixed or removable. In this regard, the memory may comprise a non-transitory computer-readable storage medium. It will be appreciated that while the memory is illustrated as a single memory, the memory may comprise a plurality of memories. The plurality of memories may be embodied on a single computing device or may be distributed across a plurality of computing devices. The memory may be configured to store information, data, applications, computer program code, instructions and/or the like for enabling the database system 10 to carry out various functions in accordance with one or more example embodiments. For example, the memory may store the reports discussed, or the reports may be stored by an external memory device in communication with the database system.

The memory 14 may be configured to buffer input data for processing by the processor 12. Additionally or alternatively, the memory may be configured to store instructions for execution by the processor. In some embodiments, the memory may include one or more databases that may store a variety of files, contents, or data sets. Among the contents of the memory, applications may be stored for execution by the processor to carry out the functionality associated with each respective application. In some cases, the memory may be in communication with one or more of the processor, report encoding circuitry 20, report identification circuitry 22, user interface 18, and/or communication interface 16, for passing information among components of database system 10.

The optional user interface 18 may be in communication with the processor 12 to receive an indication of a user input at the user interface and/or to provide an audible, visual, mechanical, or other output to the user. As such, the user interface may include, for example, a keyboard, a mouse, a joystick, a display, a touch screen display, a microphone, a speaker, and/or other input/output mechanisms. As such, the user interface may, in some example embodiments, provide means for user control of managing or processing data access operations and/or the like. In some example embodiments in which database system 10 is embodied as a server, cloud computing system, or the like, aspects of user interface may be limited or the user interface may not be present.

The communication interface 16 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network and/or any other device or module in communication with the processor 12. By way of example, the communication interface may be configured to enable communication with the database system 10 over a network. Accordingly, the communication interface may, for example, include supporting hardware and/or software for enabling wireless and/or wireline communications via cable, digital subscriber line (DSL), universal serial bus (USB), Ethernet, or other methods.

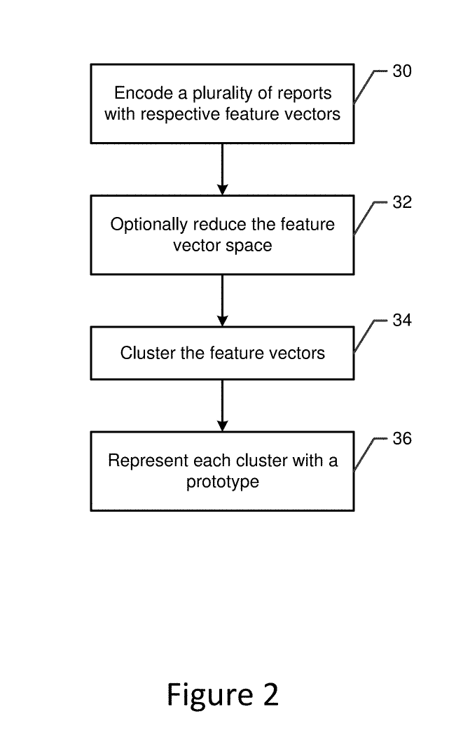

As described above, a plurality of reports may be stored by a database, such as by memory 14 or by one or more other memory devices accessible by the database system 10. With reference to the reports that are stored, the database system of an example embodiment includes means, such as the processor 12, the report encoding circuitry 20 or the like, for encoding a plurality of the reports into respective feature vectors based upon the content of the respective reports. See block 30 of FIG. 2. The resulting feature vectors may then be stored, such as in memory 14. In an example embodiment, each report is encoded based upon the words or other content of the report. For example, the database system, such as the processor, the report encoding circuitry or the like, is configured to construct a dictionary that includes each of the words included in the reports that are to be encoded. While the dictionary may include all of the different words from all of the reports to be encoded, the database system, such as the processor, the report encoding circuitry or the like, may be configured to construct the dictionary so as not to include frequently occurring, non-substantive words, such as “the”, “a”, “an”, “and” or the like, and to, instead, include the more substantive words included within the reports. In some embodiments, the database system, such as the processor, the report encoding circuitry or the like, may additionally or alternatively be configured to construct the dictionary based upon a frequency analysis of the words included within the reports such that the dictionary includes the words that appear most frequently within the reports (such as with a frequency that exceeds a predefined frequency threshold), but not those words that appear less frequently (such as with a frequency that is less than a predefined frequency threshold). Additionally or alternatively, the database system, such as the processor, the reporting encoding circuitry or the like, may be configured to construct the dictionary based upon input provided by a subject matter expert, such as a person who is expert in the subject matter to which the reports relate or an expert system trained with respect to the subject matter to which the reports relate. In this embodiment, the subject matter expert may identify the words that appear within the reports that are of most import and, as such, the resulting dictionary may include the words identified to be of importance, but not the words that appear within the reports that are not considered to be of importance.

While the dictionary may be constructed to include only single words, the database system 10, such as the processor 12, the report encoding circuitry 20 or the like, may be configured to include not only single words, but also a combination of words, such as phrases, that appear within the reports and that may be of particular significance with respect to the subject matter to which the reports relate. Although referenced herein as words, the content of the reports that is included within the dictionary may include other types of information that comprise the content of the reports including numerical information, alpha-numeric information, characters or the like. Thus, reference herein to words or combination of words includes not only words formed by a combination of alphabetical characters, but also combinations of any of a variety of characters including alphabetical, numerical and/or other types of characters.

As described above, the dictionary may include words drawn generally from the content of any of the reports being encoded. In one embodiment in which the reports are segmented, such into a plurality of sections, each of which may have a respective heading, words stored by the dictionary may be a combination of the actual word that appears in the report as well as an identification of the section in which the word appears. Thus, the same word that appears in a report may be included multiple times in the dictionary in an instance in which the same word appears in each of several different sections in the report. For example, the reports may include sections designated as Findings, History and Impression. If the word “respiration” appears in each of the three sections, the dictionary may be constructed in this embodiment to include three different representations of this same word, such as respiration-Findings, respiration-History and respiration-Impression.

Once the dictionary has been constructed, each entry, such as each word or each combination of words, within the dictionary represents a dimension of a multi-dimensional feature vector space. Thus, the database system 10 includes means, such as the processor 12, the report encoding circuitry 20 or the like, for encoding each of a plurality of reports into a respective feature vector based upon the content of the respective report. In this regard, the content of a respective report is compared to the dictionary to identify the particular words or combination of words from the dictionary that appear within the respective report. A feature vector is then constructed so as to have a plurality of dimensions, each dimension representing the presence or absence of a respective word from the dictionary in the report being encoded. By way of a simple example, a dictionary may include a first word, a second word, a third word, a fourth word, a fifth word and a sixth word representing six individual dimensions of a multi-dimensional feature vector. For a report that includes the first word, the second word, the fourth word and the sixth word, but not the third word and the fifth word, a feature vector may be constructed to be 110101 with a 1 representing the presence of a particular word from the dictionary within the respective report, a 0 representing the absence of a respective word from the dictionary in the respective report and the bits of the feature vector arranged sequentially from the first word to the sixth word. In most embodiments, the dictionary includes many more words and combinations of words and the multi-dimensional feature vector is correspondingly much larger than the example provided above.

As described below, the feature vectors may then be clustered. Prior to clustering the feature vectors, however, the dimensions of the feature vector space may, in some embodiments, be reduced. For example, the database system 10 may optionally include means, such as the processor 12, the report encoding circuitry 20 or the like, for reducing the dimensions of the feature vector space, such as by singular valued decomposition, principal component analysis or other dimensional reduction techniques. See block 32 of FIG. 2.

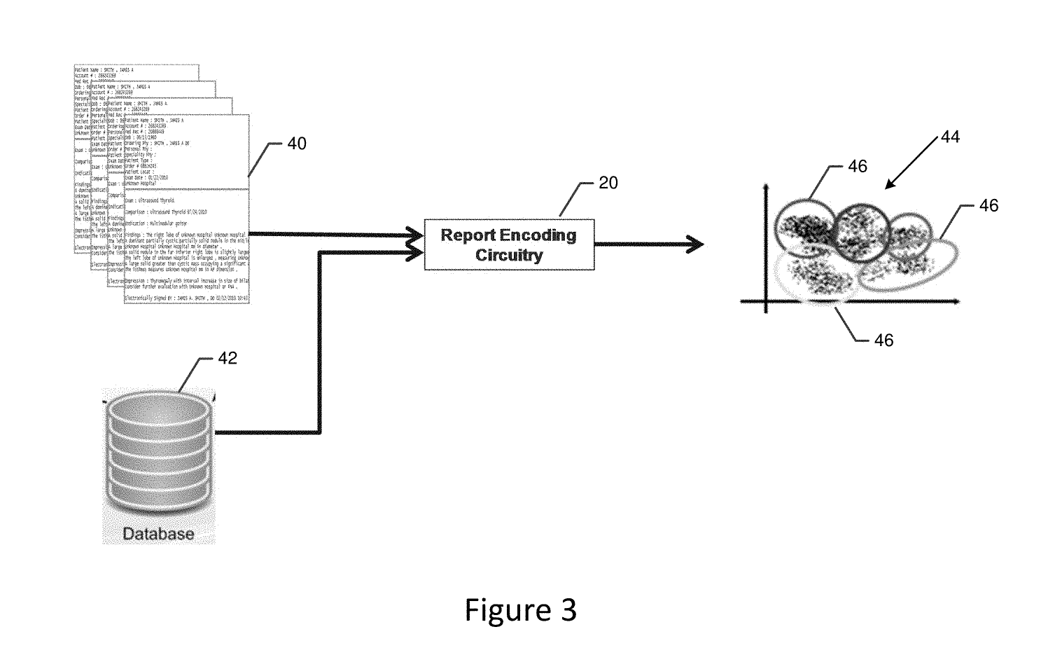

The database system 10 also includes means, such as the processor 12, the report encoding circuitry 20 or the like, for clustering the feature vectors representative of the plurality of reports. See block 34 of FIG. 2. In this regard, the feature vectors may be clustered based upon the relative proximity of the feature vectors in the multi-dimensional feature vector space such that the feature vectors that are closest to one another are clustered together. The database system, such as the processor, report encoding circuitry or the like, may cluster the feature vectors utilizing any of a variety of clustering techniques including, for example, a fuzzy c-mean clustering algorithm. By way of example, FIG. 3 depicts a plurality of reports 40 that are analyzed by the report encoding circuitry relative to a dictionary of words and combination of words stored by the database 42 in order to construct a plurality of feature vectors. Each feature vector is represented by a dot in the two-dimensional feature vector space 44 of FIG. 3. As will be recognized, the feature vectors generally have many more dimensions and, as such, the two-dimensional feature vector space of FIG. 3 is a simplistic representation of a plurality of two-dimensional feature vectors for purposes of illustration, but not of limitation.

The feature vectors are then clustered based upon the relative proximity to one another. Each cluster is designated by a closed outline 46 in the example of FIG. 3. Although the clusters of FIG. 3 have circular or elliptical shapes, the clusters may have any shape so as to include the feature vectors that are proximate one another. While the cluster may be mutually exclusive so as not to overlap with one another in some embodiments, the embodiment of FIG. 3 illustrates an embodiment in which some of the clusters may overlap such that certain of the features vectors may be included in two or more of the clusters, while others of the feature vectors are included in only a single cluster. The number of clusters may be defined in advance. Alternatively, the number of clusters may be determined automatically by the database system 10, such as the processor 12, the report encoding circuitry 20 or the like, based on cluster validity criteria, such as described, for example, Rezaee, et al., A New Cluster Validity Index for the Fuzzy c-mean, Pattern Recognition Letters 19, pages 237-46 (1998).

The database system 10 also includes means, such as the processor 12, report encoding circuitry 20 or the like, for representing each cluster with a prototype. See block 36 of FIG. 2. Although the prototype of a respective cluster may be defined in various manners, the database system of an example embodiment, such as the processor, the report encoding circuitry or the like, is configured to define the prototype of a respective cluster based upon the center point in feature space of the feature vectors that are included within the respective cluster. For example, the prototype of a respective cluster may be defined as the center point. The database system, such as the processor, the memory 14, the report encoding circuitry or the like, may then store, such as in memory, the prototypes representative of the different clusters, the feature vectors representative of the plurality of reports and an indication as to the cluster(s) to which each of the feature vectors is assigned.

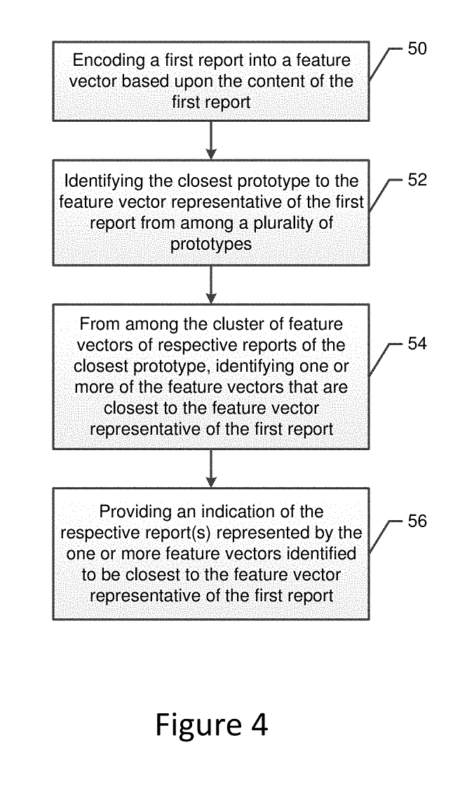

In some instances, it is desirable to identify one or more preexisting reports that are closest to a particular report (herein referenced as the first report), e.g., a new report or a report currently being evaluated, in terms of the reports sharing a number of common attributes, words or phrases. The database system 10, method and computer program product of an example embodiment therefore permits the closest preexisting reports to be identified utilizing the feature vectors and the corresponding clusters that have been constructed to represent the preexisting reports as described above. For example, the subset of preexisting reports that are closest, e.g., most related, to a first report may be identified. In this regard, the databases system includes means, such as the processor 12, report encoding circuitry 20 or the like, configured to encode the first report into a feature vector based upon the content of the first report. See block 50 of FIG. 4. As described above in conjunction with the encoding of a plurality of preexisting reports, the database system, such as the processor, the report encoding circuitry or the like, is configured to encode the first report based upon the presence or absence within the first report of the words or combinations of words that comprise the dictionary with each word or combination of words defining a respective dimension of the resulting multi-dimensional feature vector representative of the first report. In one embodiment, in an instance in which the first report includes content, such a one or more words, that are not already included in the dictionary, the database system, such as the processor, the report encoding circuitry or the like, may supplement the dictionary so as to add the one or more words included within the first report, thereby further increasing the dimensionality of the feature vector space.

Once encoded, the feature vectors representative of the preexisting reports that are closest and, therefore, most relevant, to the first report may be identified based upon the proximity of the feature vector of the first report to the feature vectors of the plurality of preexisting reports. In this regard, the database system 10 includes means, such as the processor 12, the report identification circuitry 22 or the like, configured to identify a closest prototype to the feature vector representative of the first report from among the plurality of prototypes. See block 52 of FIG. 4. As described above, each prototype is representative of a cluster of feature vectors of respective reports that are stored in a database and have been previously encoded. The closest prototype to the feature vector representative of the first report may be identified in various manners. In one embodiment, however, the distance, such as the Euclidian distance, from the feature vector representative of the first report to each of the plurality of prototypes representative of the different clusters of preexisting reports may be determined by the processor, the report identification circuitry or the like and the prototype that is closest in terms of distance, such as Euclidian distance, is identified as the closest prototype to the feature vector representative of the first report. As such, the database system, such as the processor, the report identification circuitry or the like, has now identified those reports having feature vectors included within the cluster having the closest prototype to be the closest and, therefore, most relevant to the first report.

The database system 10 of this example embodiment also includes means, such as the processor 12, the report identification circuitry 22 or the like, for identifying from among the feature vectors of respective reports included within the cluster represented by the closest prototype, one or more of the feature vectors that are closest to the feature vector representative of the first report. See block 54 of FIG. 4. The closeness of the feature vectors of respective reports included within the cluster represented by the closest prototype to the feature vector representative of the first report may be defined in various manners including, for example, the distance, such as the Euclidian distance, from the feature vectors representative of respective reports included within the cluster represented by the closest prototype to the feature vector representative of the first report. While the closest prototype and the closest feature vectors may be identified utilizing the same metric, such as Euclidian distance, the closest prototype and the closest feature vectors may be identified utilizing different metrics in other embodiments.

In this example embodiment, however, the database system 10 such as the processor 12, the report identification circuitry 22 or the like, is configured to determine the distance, such as the Euclidian distance, between each of the feature vectors of respective reports included within the cluster represented by the closest prototype and the feature vector representative of the first report and to identify one or more of the feature vectors of the respective reports included within the cluster represented by the closest prototype that are separated from the feature vector representative of the first report by the shortest distance. The number of feature vectors of respective reports included within the cluster represented by the close prototype that are identified to be closest to the feature vector representative of the first report may be defined by the user who may request that a predefined number, such as 10, of the closest reports be identified. Alternatively, the number of feature vectors of respective reports included within the cluster represented by the closest prototype that are identified as being closest to the feature vector representative of the first report may be defined by the feature vectors themselves with each of the feature vectors of the respective reports included within the cluster represented by the closest prototype that are within a predetermined distance of the feature vector representative of the first report being identified as the closest feature vectors. Regardless of the number, the feature vector(s) of the respective reports included within the cluster represented by the closest prototype that are closest and, therefore, most relevant to the feature vector representative of the first report are identified.

The database system 10 of this example embodiment also includes means, such as the processor 12, the report identification circuitry 22 or the like, for providing an indication of the respective report(s) represented by the one or more feature vectors of the respective reports included within the cluster represented by the closest prototype that were identified to be closest to the feature vector representative of the first report. See block 56 of FIG. 4. The indication that is provided to a user, such as upon the user interface 18, may be copies of the reports themselves, links to the reports or other indicia representative of the reports. As such, the user may then review the reports that have been identified to be closest to the first report and, in some embodiments, may become better informed with respect to the manner in which the subject of matter of the first report should be addressed. With respect to a medical report, for example, a healthcare professional may review the closest preexisting reports to identify courses of treatments, likely outcomes and other factors that may influence the course of treatment for the patient for whom the first report relates.

In addition to the content of the reports, a number of the reports, such as each report, may include associated metadata that provides information regarding the report and/or the manner in which the report was constructed. With respect to a medical report, for example, the metadata may provide information regarding the patient demographic for which the report relates, the examination procedure for which the report relates or the like. Further, in instances in which the report is a radiology or other imaging report, the metadata may include information relating to the parameters of the device that captured the image, such as parameters specific to the modality of the imaging technique.

In some embodiments, the dictionary is constructed so as to include not only the words that form the content of the reports to be encoded, but also the metadata associated with the reports. As such, the different metadata associated with the reports that are encoded may define additional dimensions of the multi-dimensional feature vector space. As such, the database system 10 of this example embodiment, such as the processor 12, the report encoding circuitry 20 or the like, may be configured to encode the reports, such as the first report as well as the preexisting reports, by encoding the reports into a feature vectors based upon both the content and the metadata associated with the respective reports.

While the metadata may be utilized to define additional dimensions of the feature vector space as described above, the metadata may alternatively be utilized as a filtering criteria with respect to the prototypes that are considered in relation to the feature vector of the first report. In this regard, the metadata associated with the reports may be stored, such as in memory 14, in association with the feature vectors representative of the reports and the prototype representative of the cluster that includes the features vectors. As such, the database system 10, such as the processor 12, the report identification circuitry 22 or the like, of this embodiment may compare the metadata associated with the first report to the metadata stored in association with each of the different prototypes and may consider only those prototypes having metadata associated therewith that corresponds to, such as being the same as, the metadata associated with the first report in conjunction with the determination of the closest prototype. Thus, the prototypes that are considered in conjunction with identification of the closest prototype to the feature vector representative of the first report are only those prototypes that are associated with metadata that corresponds to the metadata associated with the first report and not the prototypes that are associated with different metadata that does not correspond with the metadata associated with the first report. In other words, the database system 10 of this example embodiment, such as the processor 12, the report identification circuitry 22 or the like, is further configured to filter the plurality of prototypes based upon the metadata associated with the first report such that the plurality of prototypes from which the closest prototype is identified are each representative of a cluster of feature vectors of respective reports that have metadata associated therewith which corresponds to the metadata of the first report. As such, the resulting analysis of the prototypes in order to identify the closest prototype may be simplified based upon the consideration of the metadata associated with the first report.

The database system 10, method and computer program product of an example embodiment provide for the closest and, therefore, the most relevant reports to be identified in an efficient manner by conducting the search in a multi-dimensional feature vector space as opposed to conducting the search directly in relation to the reports themselves. By conducting the search in an efficient manner, the database system, method and computer program product reduce the consumption of processing resources and processing time and provide users with accurate results in a much more expeditious manner than conventional word searching techniques. These technical advantages provided by the database system, method and computer program product are only enhanced as the number of reports increases as is anticipated to occur over the course of time as the number of reports grows and grows with such increases potentially crippling conventional word searching techniques, while still being able to be searched in an efficient manner by the database system, method and computer program product of the example embodiments described herein.

It will be appreciated that the figures are each provided as examples and should not be construed to narrow the scope or spirit of the disclosure in any way. In this regard, the scope of the disclosure encompasses many potential embodiments in addition to those illustrated and described herein. Numerous other configurations may also be used to implement embodiments of the present invention.

FIGS. 2 and 4 illustrate operations of a method, database system 10 and computer program product according to some example embodiments. It will be understood that each operation of the flowcharts, and combinations of operations in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, memory 14) storing instructions executable by a processor in the computing device (for example, by processor 12). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, database system 10) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, database system 10 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed is:

1. A database system configured to identify a subset of reports, the database system comprising:
report encoding circuitry configured to encode a first report into a feature vector based upon content of the first report;
report identification circuitry configured to:
identify a closest prototype to the feature vector representative of the first report from among a plurality of prototypes, each prototype representative of a cluster of feature vectors of respective reports stored in a database;
from among the cluster of feature vectors of respective reports of the closest prototype, identify one or more of the feature vectors that are closest to the feature vector representative of the first report; and
provide an indication of the respective report(s) represented by the one or more feature vectors identified to be closest to the feature vector representative of the first report.

2. A database system according to claim 1 wherein the first report and the respective reports stored in the database have metadata associated therewith, and wherein the report encoding circuitry is configured to encode the first report by encoding the first report into the feature vector based upon the content of the first report and the metadata associated with the first report.

3. A database system according to claim 1 wherein the first report and the respective reports stored in the database have metadata associated therewith, and wherein the report identification circuitry is further configured to filter the plurality of prototypes based upon the metadata associated with the first report such that the plurality of prototypes from which the closest prototype is identified are each representative of a cluster of feature vectors of respective reports having metadata associated therewith which corresponds to the metadata associated with the first report.

4. A database system according to claim 1 wherein each prototype represents a center point of the feature vectors of the respective cluster.

5. A database system according to claim 1 wherein the feature vectors representative of the first report and the respective reports stored in the database are based upon words included in the respective report.

6. A database system according to claim 5 wherein the report encoding circuitry is configured to encode the first report into the feature vector by encoding the first report into a multi-dimensional feature vector with each dimension representative of a presence or absence of one or more words within the first report.

7. A database system according to claim 1 wherein the report identification circuitry is configured to identify the closest prototype by identifying the prototype that has a shortest Euclidean distance to the feature vector representative of the first report as the closest prototype.

8. A database system according to claim 1 wherein the report identification circuitry is configured to identify one or more of the feature vectors that are closest to the feature vector representative of the first report by identifying the one or more feature vectors from among the respective reports of the closest prototype that have a shortest Euclidean distance to the feature vector representative of the first report as the closest feature vector(s).

9. A method for identifying a subset of reports, the method comprising:
encoding, with report encoding circuitry, a first report into a feature vector based upon content of the first report;
identifying, with report identification circuitry, a closest prototype to the feature vector representative of the first report from among a plurality of prototypes, each prototype representative of a cluster of feature vectors of respective reports stored in a database;
from among the cluster of feature vectors of respective reports of the closest prototype, identifying, with the report identification circuitry, one or more of the feature vectors that are closest to the feature vector representative of the first report; and
providing, with the report identification circuitry, an indication of the respective report(s) represented by the one or more feature vectors identified to be closest to the feature vector representative of the first report.

10. A method according to claim 9 wherein the first report and the respective reports stored in the database have metadata associated therewith, and wherein encoding the first report comprises encoding the first report into the feature vector based upon the content of the first report and the metadata associated with the first report.

11. A method according to claim 9 wherein the first report and the respective reports stored in the database have metadata associated therewith, and wherein the method further comprises filtering the plurality of prototypes based upon the metadata associated with the first report such that the plurality of prototypes from which the closest prototype is identified are each representative of a cluster of feature vectors of respective reports having metadata associated therewith which corresponds to the metadata associated with the first report.

12. A method according to claim 9 wherein each prototype represents a center point of the feature vectors of the respective cluster.

13. A method according to claim 9 wherein the feature vectors representative of the first report and the respective reports stored in the database are based upon words included in the respective report.

14. A method according to claim 13 wherein encoding the first report into the feature vector comprises encoding the first report into a multi-dimensional feature vector with each dimension representative of a presence or absence of one or more words within the first report.

15. A method according to claim 9 wherein identifying the closest prototype comprises identifying the prototype that has a shortest Euclidean distance to the feature vector representative of the first report as the closest prototype.

16. A method according to claim 9 wherein identifying one or more of the feature vectors that are closest to the feature vector representative of the first report comprises identifying the one or more feature vectors from among the respective reports of the closest prototype that have a shortest Euclidean distance to the feature vector representative of the first report as the closest feature vector(s).

17. A computer program product for identifying a subset of reports, the computer program product comprising at least one non-transitory computer-readable storage medium storing computer-executable instructions that, when executed, cause an apparatus to:
encode a first report into a feature vector based upon content of the first report;
identify a closest prototype to the feature vector representative of the first report from among a plurality of prototypes, each prototype representative of a cluster of feature vectors of respective reports stored in a database;
from among the cluster of feature vectors of respective reports of the closest prototype, identify one or more of the feature vectors that are closest to the feature vector representative of the first report; and
provide an indication of the respective report(s) represented by the one or more feature vectors identified to be closest to the feature vector representative of the first report.

18. A computer program product according to claim 17 wherein the first report and the respective reports stored in the database have metadata associated therewith, and wherein computer-executable instructions for encoding the first report comprise computer-executable instructions configured to encode the first report into the feature vector based upon the content of the first report and the metadata associated with the first report.

19. A computer program product according to claim 17 wherein the first report and the respective reports stored in the database have metadata associated therewith, and wherein the computer-executable instructions are further configured to filter the plurality of prototypes based upon the metadata associated with the first report such that the plurality of prototypes from which the closest prototype is identified are each representative of a cluster of feature vectors of respective reports having metadata associated therewith which corresponds to the metadata associated with the first report.

20. A computer program product according to claim 17 wherein the feature vectors representative of the first report and the respective reports stored in the database are based upon words included in the respective report, and wherein the computer-executable instructions for encoding the first report into the feature vector comprise computer-executable instructions configured to encode the first report into a multi-dimensional feature vector with each dimension representative of a presence or absence of one or more words within the first report.
